(19) United States
(12) Patent Application Publication
(10) Pub. No.: US 2008/0081319 A1
(43) Pub. Date: Apr. 3, 2008

(54) SYSTEM FOR ASTROLOGICAL AND NUMEROLOGICAL CLASSIFICATION AND METHOD FOR ENTERTAINMENT RELATED THERETO

(76) Inventor: JAMES ROBERT ARCHIBALD DUNLOP, Ashwell (GB)

Correspondence Address: LACKENBACH SIEGEL, LLP, LACKENBACH SIEGEL BUILDING, 1 CHASE ROAD, SCARSDALE, NY, 10583, US

(21) Appl. No.: 11/864,658

(22) Filed: Sep. 28, 2007

(30) Foreign Application Priority Data
Sep. 29, 2006 (GB) 0619245.4

(51) Int. Cl. G09B 19/00

(52) U.S. Cl. 434/106

(57) ABSTRACT

An entertainment astrological and numerological system and method is provided for deriving a combined astrological and numerological classification for a subject and providing the same to the subject for enjoyment and entertainment value. The method comprises the steps of: identifying an astrological classification for a subject from said subject's date and time of birth based upon a specific designated system for making such identifying step, the astrological classification system comprising at least said subject's designated zodiac sign and a designated associated element; and, identifying a numerological classification for a subject; the entertainment classification step of identifying a numerological classification comprising the steps of: determining a number between 1 and n for said subject's name utilising a defined classification system of correspondence between the letters of the alphabet and said numbers 1 to n, summing the numbers for each letter of each name of said subject's full name or name by which said subject is known and dividing the sum S by n, wherein if the sum S is exactly divisible by n the subject's numerological classification is n and if the sum S is not exactly divisible by n the subject's numerological classification is the remainder R, where R is between 1 and n−1; and, combining said subject's so calculated astrological and numerological classifications to provide a combined astrological and numerological classification method for said subject as an entertainment system.

### CROSS REFERENCE TO RELATED APPLICATIONS

This application relates to and claims priority from the following application: Ser. No. GB 0619245.4 filed on Sep. 29, 2006 in Great Britain, the entire contents of which are herein incorporated by reference

### FIGURE SELECTED FOR PUBLICATION

FIG. 1

### BACKGROUND OF THE INVENTION

1. Field of the Invention

This invention relates to astrological and numerological methods, processes and systems and in particular concerns a method and system for subject classification.

2. Description of the Related Art

Astrology has been practised in many civilisations throughout the history of mankind and in ancient times astrologers were often highly skilled astronomers who devised systems for interpreting the meaning of planetary movement and interaction. Over the course of time the subjects of astrology and astronomy separated to the position they occupy today with astronomy being concerned with the precise scientific understanding of celestial bodies distinct from the predictive and interpretative art, or some would say belief, of astrology.

In western astrology each of the twelve signs of the zodiac are assigned to one of the four traditional elements of Fire, Earth, Air and Water according to the following scheme: Fire: Aries, Leo, Sagittarius; Earth: Taurus, Virgo, Capricorn; Air: Gemini, Libra, Aquarius; Water: Cancer, Scorpio, Pisces.

In this respect each individual has an elemental classification of either Fire, Earth, Air or Water depending on the individual's star sign and therefore ultimately date and time of birth. For example, if a person has Capricorn as their star sign they will by definition have Earth as their element.

Nowadays astrology is a global commercial entertainment-based and performance-art based industry supported by a number of systems found in all mainstream media. For example, such Astrology services are provided over the Internet and over other telecommunications networks, for example in the form of premium rate telephone lines and mobile phone messaging which allow certain interactions for entertainment and self-gratification, in addition to the traditional printed media.

Numerology is another interpretive entertainment and performance art which is often practised by astrologers. The standard practice of numerology as it exists today has probably been in use since the end of the nineteenth century. The methodology is fairly complex in that it involves generating numbers for variables such as a person's name, a person's birth date and/or a combination of the two.

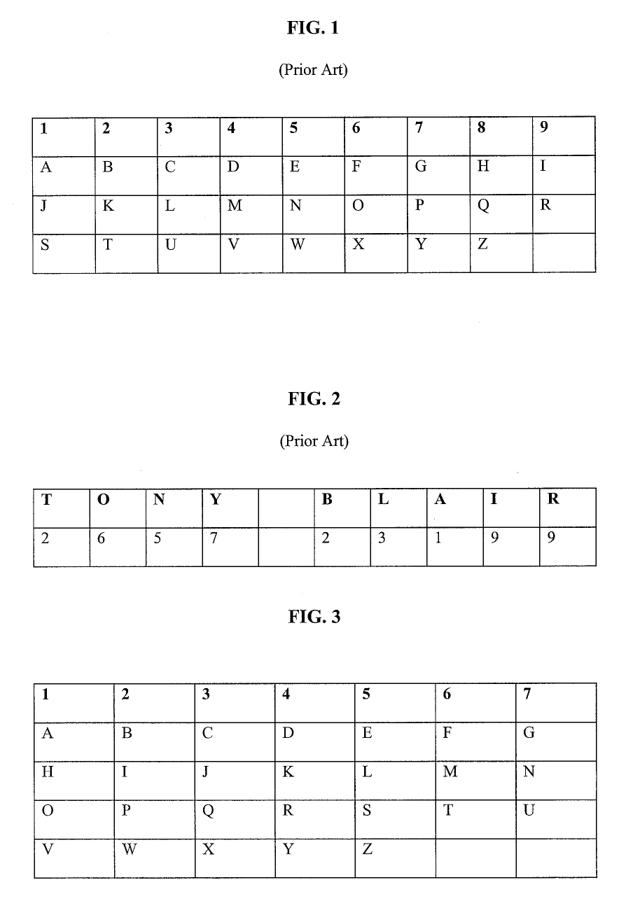

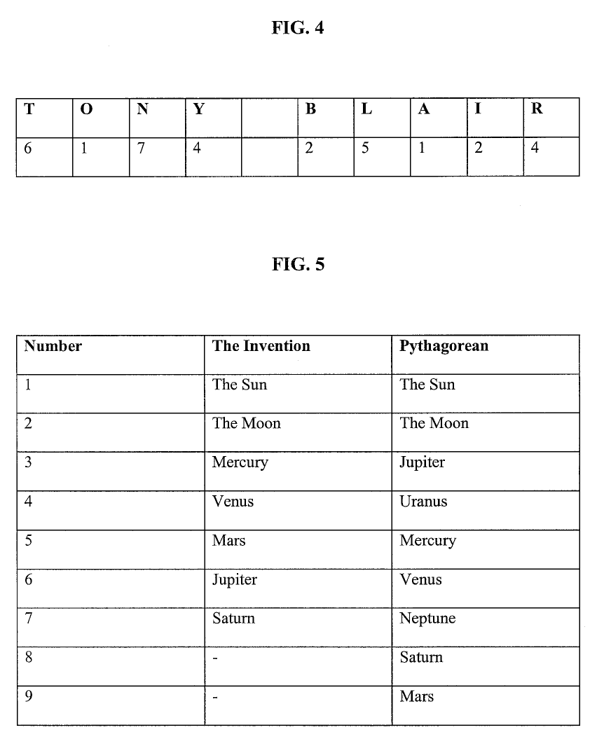

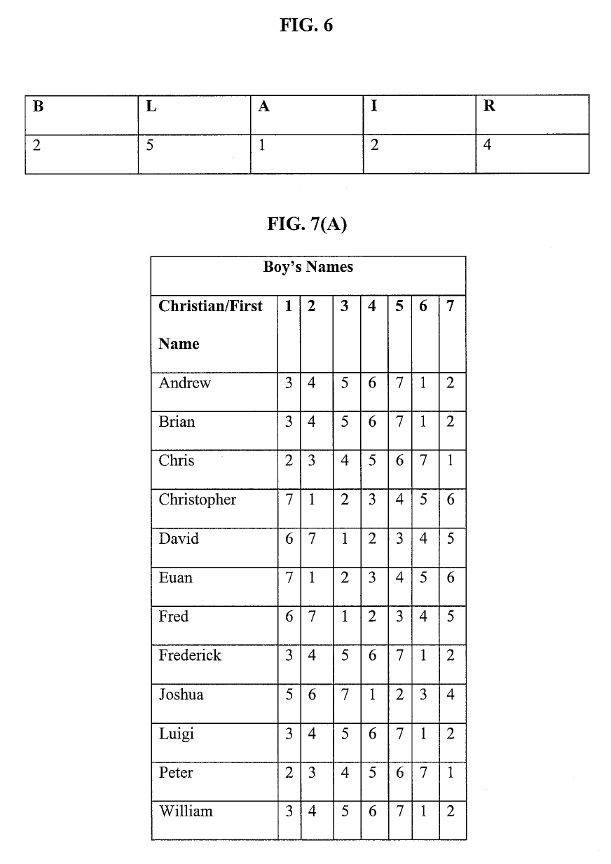

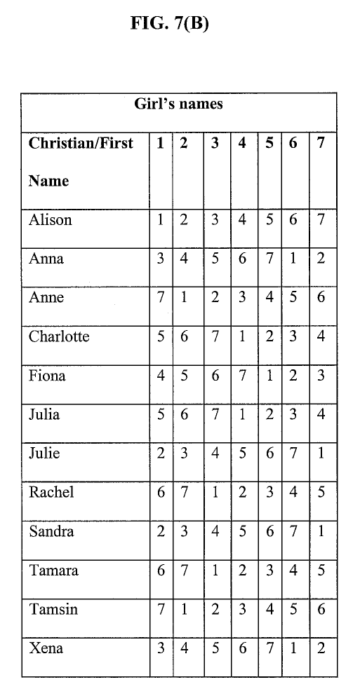

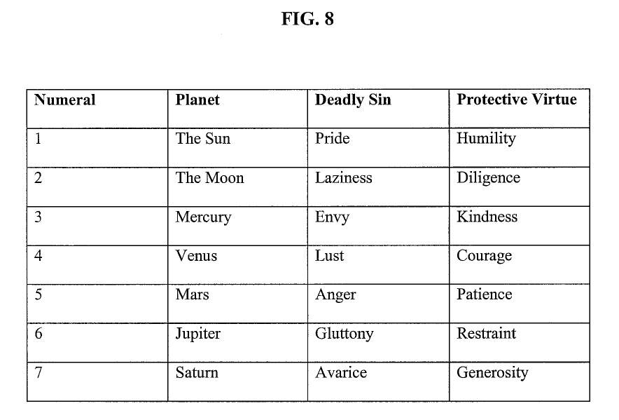

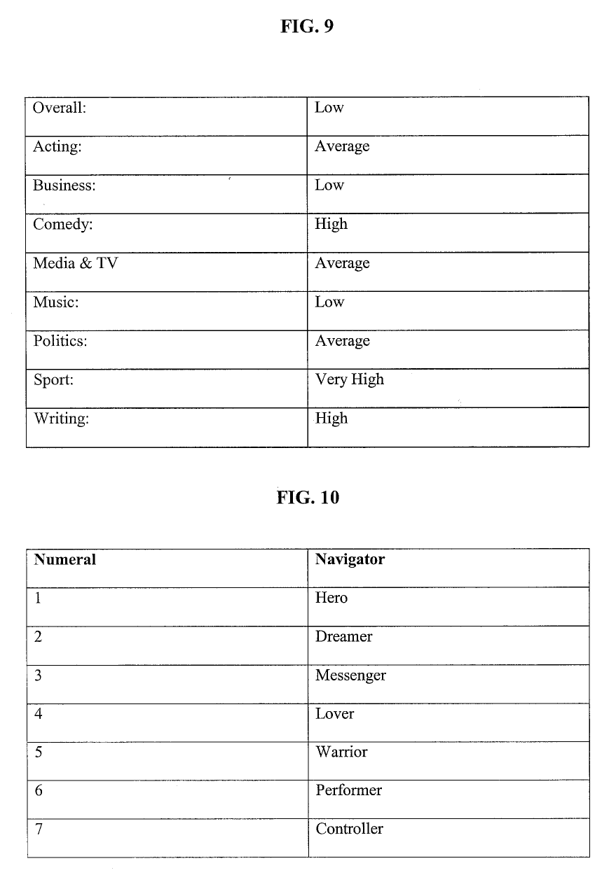

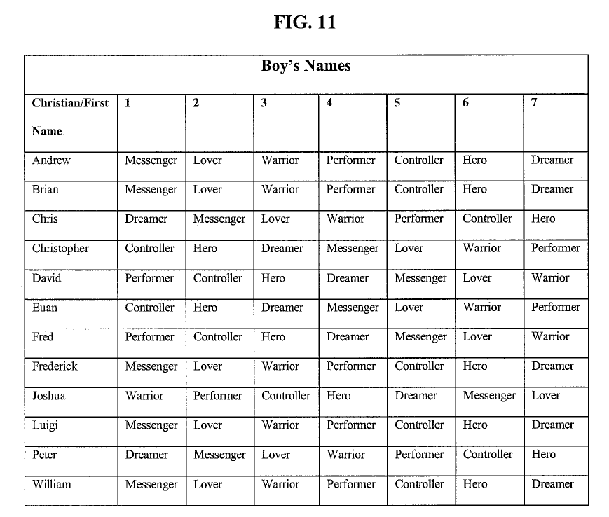

The most common system of numerology in use today is often known as the Pythagorean system which utilises a system of correspondence between the letters of the alphabet and the numbers 1 to 9. This is best explained with reference to the table of FIG. 1 where it can be seen that each letter of the alphabet is assigned a number between 1 and 9. The first letter in the alphabet, A, is assigned the number 1, the second letter, B, is assigned the number 2 and so on until the ninth letter of the alphabet I which is assigned the number 9 and then the pattern is repeated with the tenth letter of the alphabet being assigned the number 1 and so on.

Referring now to the table in FIG. 2, it can be seen that using the Pythagorean system the letters in each name of the name “Tony Blair” add up to 44 and under the Pythagorean system the digits of 44 are added together so that 4 plus 4 equals 8 so that according to the standard system of Pythagorean numerology the number associated with the name Tony Blair is 8. Each of these numbers has a particular meaning which is often linked to one of the planets revolving our Sun, based on order from the Sun, a planet for example, number 1 is active and designated/connected with leadership and linked with the Sun, whereas number 2 is passive and designated/connected with The Moon as a planet and so forth. As an entertainment or performance-art system, Numerological systems provide astrologers and others with additional tools and methods for practicing their interpretative arts.

There is a long felt but unsatisified need in the commercial astrology industry for innovative entertainment and intellectual engagement methodologies, and in particular a requirement for an improved method and system of generating and maintaining a subject classification beyond the traditional known classification of the twelve signs of the zodiac.

### OBJECTS AND SUMMARY OF THE PRESENT INVENTION

The present invention seeks to respond to one of the needs noted above.

According to an aspect of the present invention there is provided an astrological and numerological method for deriving a combined astrological and numerological classification for a subject, said method comprising the steps of: identifying an astrological classification for a subject from said subject's date and time of birth, said astrological classification comprising at least said subject's zodiac sign and associated element; and, identifying a numerological classification for a subject; said step of identifying a numerological classification comprising the steps of: determining a number between 1 and n for said subject's name utilising a system of correspondence between the letters of the alphabet and said numbers 1 to n, summing the numbers for each letter of each name of said subject's full name or name by which said subject is known and dividing the sum S by n, wherein if the sum S is exactly divisible by n the subject's numerological classification is n and if the sum S is not exactly divisible by n the subject's numerological classification is the remainder R, where R is between 1 and n−1; and, combining said subject's astrological and numerological classifications to provide a combined astrological and numerological classification for said subject.

The methodology of the above aspect of the present invention is predicated on the principle that a subject's star sign or element is determined at birth and cannot be changed, in a sense it is one's destiny. The numeral, on the other hand, can be changed. A person can call themselves whatever they like and in this respect a change of name may be considered to change that person's fortune since a name change resulting in a change of numeral will, under current numerological thinking, attract the energies of a different planet. In the context of this description the term “full name” means the name by which a person is known and may include one or many elements which may be names or initials etc, for example: John F Kennendy, Sammy Davies Junior, Madonna, Prince Harry, Mark Raymond Shelley etc.

The above aspect of the present invention provides a novel classification methodology for providing individuals with a combined astrological and numerological classification based on the individual's birth date and time, which is fixed, and their name by which they are known, which may be changed.

Preferably the method further comprises the step of assigning a planet to each numerological classification 1 to n. In this respect the interpretive meanings of the numeral are derived from the planets (including The Sun and The Moon) they relate to. Thus, when the method according to the above aspect of the invention is used for prediction, the movements of The Sun, and the planets will be seen as having an effect on people's lives according to the numeral associated with their name. It is to be understood that The Sun and The Moon are considered to be planets in traditional astrology and where reference is made to the planets in the context of this patent specification this not only includes the scientifically accepted planets of the solar system or a subset thereof, but also The Sun and The Moon in accordance with traditional astrological methods.

The planets may be assigned to the numerological classifications 1 to n in any order. In one particular embodiment the planets are assigned to the numerological classifications 1 to n in accordance with the standard system of Pythagorean numerology or the Chaldean order, with the first planet of the Pythagorean order assigned to any one of the classifications 1 to n. The Chaldean order is a system of ordering the planets which is well known to astrologers and has considerable historical pedigree, the Chaldean system orders the seven traditional planets (including The Sun and The Moon) according to their speed, with the planets going successively faster. For example, seven planets placed in the Chaldean order would be successively Saturn, Jupiter, Mars, the Sun, Venus, Mercury, the Moon. The Moon is the fastest planet and the planet following The Moon is Saturn, the slowest, that is to say the cycle repeats itself. In this respect the invention contemplates embodiments where the planets are assigned to the numbers according to the Chaldean order, for example if The Sun is one, Venus is 2, Mercury 3, The Moon 4, Saturn 5, Jupiter 6 and Mars 7.

In other embodiments the Sun could be any of the other numbers between 1 and n provided the order, the Chaldean order, were maintained in the manner previously mentioned. For example, if Mars were 1, the Sun would be 2, Venus 3 and so on. In early versions of the Pythagorean System, the Sun is 1, the Moon 2, Jupiter 3, the Sun 4, Mercury 5, Venus 6, the Moon 7, Saturn 8 and Mars 9. In the modern version, the Sun is 1, the Moon 2, Jupiter 3, Uranus 4, Mercury 5, Venus 6, Neptune 7, Saturn 8 and Mars 9. As previously mentioned the invention contemplates the embodiments where the first planet, in this case The Sun is assigned to any one of the numbers 1 to n, that is to say The Sun may be assigned with the number 4, for example so that the moon is 5, Jupiter is 6, Uranus 7, Mercury 8, Venus 9, Neptune 1, Saturn 2 and Mars 3.

In a preferred embodiment of the present invention the planets are assigned to the numerological classifications 1 to n in the order from the sun; including Sun, Moon, Mercury, Venus, Mars, Jupiter, Saturn and in a most preferred embodiment the number 1 is assigned to the Sun so that the Moon is 2, Mercury 3, Venus 4, Mars 5, Jupiter 6 and Saturn 7.

Preferably n=7. In this respect each of the seven numbers is connected with one of the traditional seven planets, that is to say the Sun, the Moon, Mercury, Venus, Mars, Jupiter and Saturn. Uranus, Neptune and Pluto (now relegated as a planet), the so called discovered planets, and are not a part of the system, as in the later versions of the Pythagorean system where Uranus and Neptune are present. In this respect the method provides seven numerological classifications comprising the numbers of 1 to 7. In preferred embodiments the elements are designated as comprising identifiers for the four traditional astrological elements, Fire, Earth, Air and Water. Other schemes might be contemplated within the scope of the present disclosure, for example the traditional Chinese scheme, which uses the elements of Fire, Earth, Metal, Water and Wood. In preferred embodiments the method of the present invention therefore provides 28 discrete combinations for subject classification comprising Fire 1 to 7, Earth 1 to 7, Air 1 to 7 and Water 1 to 7.

Preferably the combined astrological and numerological classification begins with the subject's element and ends with the subject's numerological classification.

In preferred embodiments of the present invention, the entertainment method further comprises the step of assigning a respective deadly sin and/or contrary virtue to each of said numerological classifications 1 to n. For example, the number 1 assigned to the planet The Sun is also associated with the deadly sin of pride and the contrary virtue, or what inventor has referred to as the “protective virtue”, of humility, following the proposed classification system and method herein provides an enhanced entertainment feature and an enhanced entertainment system of operation.

In another embodiment of the method of the present invention the method further comprises the step of assigning values of a subject's potential for success to respective activities for each astrological and numerological combination. In preferred embodiments the potential for success may be considered to be a measure of fame potential by assigning values to one or more of the categories of, for example: acting, business, comedy, media and TV, music, politics, sport and writing. For example, an individual having an astrological and numerological classification of “Earth 3” may have assigned a low overall fame potential, but an average potential for acting, low potential for business, high potential for comedy, average potential for media and TV, low potential for music, average potential for politics, a very high potential for sport and a high potential for writing. Thus, the proposed method of the present entertainment and operational system invention contemplates predictive methodologies based on an individual's numerological and astrological classification, which of course may change if that individual were to change their name, either in a formal legal sense or simply by changing the name by which they are known to others.

The method according to the above aspect of the invention also contemplates embodiments where the method further comprises the step of storing the names and combined astrological and numerological classifications of a plurality of famous people and retrieving the names of those people for association with a subject having a matching classification. For example, a database or list may contain the names of famous people for each astrological numerological classification so that individuals may enquire to determine those celebrities that share the same astrological numerological classification.

The present invention contemplates the technical implementation of the above mentioned methods in many different forms, including implementation in a computer software application programme for execution on a suitable processor which may be associated with or part of a server connected to a communications network such as the Internet for access, as a paid service or otherwise, by individuals wishing to determine their astrological numerological classification according to the above methods and obtain profile, interpretation, and prediction data relating to their lives. Many astrological services and methods are currently provided to the public over telecommunication networks, for example the Internet or mobile phone networks. For example, a user may access a server implementing the processing steps of the above method over a telecommunications network from an interactive communications device including for example a hand held device such as a mobile phone or PDA, or client computer and, using a client server type relationship, obtain predictive information about themselves based on their combined astrological and numerological classification communicated to a processor by an interactive process over a communications network.

In this respect according to another aspect of the present invention there is provided a method for determining a combined astrological and numerological classification for a subject, in a question and answering session, said method comprising the steps of: interactively communicating, via an interactive communications device, a series of questions to a user attempting to establish a combined astrological and numerological classification of a subject; permitting said user to provide an answer to said series of questions; said answers including at least said subject's name and date of birth and optionally time of birth; identifying an astrological classification for said subject from said subject's date of birth and optionally time of birth, said astrological classification comprising at least said subject's zodiac sign and/or associated element; and, identifying a numerological classification for said subject; said step of identifying a numerological classification including the steps of: determining a number between 1 and n for said subject's name utilising a system of correspondence between the letters of the alphabet and said numbers 1 to n, summing the numbers for each letter of each name of said subject's fall name or name by which said subject is known and dividing the sum S by n, wherein if the sum S is exactly divisible by n the subject's numerological classification is n and if the sum S is not exactly divisible by n the subject's numerological classification is the remainder R, where R is between 1 and n−1; and, combining said subject's astrological and numerological classifications to generate a combined astrological and numerological classification for said subject interactively communicating, via said interactive communications device, said combined astrological and numerological classification to said user.

The above interactive method may be implemented utilising a computer memory storing feature, system, or apparatus, and thereon storing an application program for controlling the execution of a processor to determine a combined astrological and numerological classification (for a subject according to the present system), in a question and answering session, the application program controlling the processor to: display a set of one or more questions to a user attempting to determine a combined astrological and numerological classification for a subject; permit said user to provide an answer to said set of one or more questions, said answers including at least said subject's name and date of birth; identify an astrological classification for said subject from said subject's date of birth, said astrological classification comprising at least said subject's zodiac sign and/or associated element; and, determine a number between 1 and n for said subject's name utilising a system of correspondence between the letters of the alphabet and said numbers 1 to n, sum the numbers for each letter of each name of said subject's full name or name by which said subject is known and divide the sum S by n, and if the sum S is exactly divisible by n the subject's numerological classification is n and if the sum S is not exactly divisible by n the subject's numerological classification is the remainder R, where R is between 1 and n−1; and, combine said subject's astrological and numerological classifications to generate a combined astrological and numerological classification for said subject; communicate said combined astrological and numerological classification to said user.

In this respect in another aspect of the present invention there is provided a system for deriving a combined astrological and numerological classification for a subject, said system comprising: means for identifying an astrological classification for a subject from said subject's date and time of birth, said astrological classification comprising at least said subject's zodiac sign and associated element; and, means for identifying a numerological classification for a subject, including: means for determining a number between 1 and n for said subject's name utilising a system of correspondence between the letters of the alphabet and said numbers 1 to n, means for summing the numbers for each letter of each name of said subject's full name or name by which said subject is known and dividing the sum S by n, and, wherein if the sum S is exactly divisible by n the subject's numerological classification is n and if the sum S is not exactly divisible by n the subject's numerological classification is the remainder R, where R is between 1 and n−1; and, means for combining said subject's astrological and numerological classifications to provide a combined astrological and numerological classification for said subject.

The above mentioned system is preferably implemented in a computer system and/or a telecommunications network as previously discussed.

In another aspect of the present invention there is provided a system for determining a combined astrological and numerological classification for a subject, in a question and answering session, said system comprising: an application program to control a processor for displaying, on a display means, a series of questions to a user attempting to establish a combined astrological and numerological classification of a subject; data input means adapted to interface with said processor to permit said user to provide an answer to said set of one or more questions including at least said subject's name and date of birth; a database into which said answers are stored by said processor under instructions by said application program; said processor allowing said user to answer said set of one or more selected questions using said data input means; said application program instructs said processor to: (a) identify an astrological classification for a subject from said subject's date of birth, said astrological classification comprising at least said subject's zodiac sign and/or associated element; (b) determine a number between 1 and n for said subject's name utilising a system of correspondence between the letters of the alphabet and said numbers 1 to n, (c) sum the numbers for each letter of each name of said subject's full name or name by which said subject is known and dividing the sum S by n, and, if the sum S is exactly divisible by n the subject's numerological classification is n and if the sum S is not exactly divisible by n the subject's numerological classification is the remainder R, where R is between 1 and n−1; and, wherein said application program instructs said processor to combine said subject's astrological and numerological classifications to provide a combined astrological and numerological classification for said subject and thereafter form a database structure in said database from said provided information for the creation of an astrological and numerological classification for said subject. It is to be understood that said processor may be a distributed for distributed processing as is well known in the art, for example by data communication to distributed processing elements linked together on a communications network.

According to another aspect of the invention there is provided a method for deriving a numerological classification for a subject, said method comprising the steps of: determining a number between 1 and n for said subject's name or surname utilising a system of correspondence between the letters of the alphabet and said numbers 1 to n, summing the numbers for each letter of said subjects surname or each name of said subject's full name or name by which said subject is known and dividing the sum S by n, wherein if the sum S is exactly divisible by n the numerological classification of the subjects name or surname is n and if the sum S is not exactly divisible by n the subject's numerological classification is the remainder R, where R is between 1 and n−1.

The present invention also contemplates a method for deriving just a numerological classification for a subject without consideration of the subject's astrological classification based on the subject's date and time of birth. For example, when the numerological classification of the subject's surname is determined by the above method, the method further comprises the step of identifying respective first and/or other names which when added to the subject's surname will provide a pre-determined numerological classification. The above aspect of the invention therefore contemplates embodiments where, for example a parent may use the above numerological method to select a numerological classification when choosing a baby's name. As the baby's surname will be known the numerological classification of the surname can be determined and this can be combined with a list of first or Christian names to show what the numerological classification of the full name, Christian name plus surname, will provide. For example, the surname Blair may, in one embodiment of the present invention where n=7, provide a numerological classification of 7 and this can then be compared with various Christian names to help the parent select a name which, when combined with a known surname, will give a pre-selected numerological classification. For example, if a parent requires a child having the surname Blair to have a numerological classification of 6, the names Christopher and Euan would be available. The above method therefore provides an aid for the selection of baby's names where it is desired that the child has a particular numerological classification to be combined with the astrological classification determined by that person's date and time of birth.

### BRIEF DESCRIPTIONS OF THE DRAWINGS

Various embodiments of the invention will now be more particularly described by way of example only with reference to the accompanying drawings in which:

FIG. 1 is a conventional correspondence table for the letters of the alphabet and the numbers 1 to 9 in accordance with Pythagorean numerology.

FIG. 2 is an example of the conventional application of the correspondence table of FIG. 1.

FIG. 3 is a correspondence table for the letters of the alphabet and the numbers 1 to 7 in accordance an embodiment of the present invention.

FIG. 4 is an example of the application of the correspondence table of FIG. 3.

FIG. 5 is a table showing the relationship between numerals and the astrological planets for an embodiment of the invention and Pythagorean numerology.

FIG. 6 is a table showing an example of the application of the correspondence table of FIG. 3 to the surname part of a subject's name.

FIGS. 7(A)a and 7(B) are respective tables of Boys and Girls first/Christian names for use in an embodiment of the present invention;

FIG. 8 is a table showing the relationship between numerals, the astrological planets, the seven deadly sins and corresponding protective virtues according to an embodiment of the present invention; and,

FIG. 9 is a table showing an example of a subject's potential for success in various activities in accordance with an embodiment of the present invention.

### DETAILED DESCRIPTION OF THE PREFERRED EMBODIMENTS

The astrological and numerological method according to one embodiment of the invention implements a new numerological methodology for identifying a numerological classification for a subject, that is to say it provides seven different numerological classification comprising the numerals 1 to 7. Each of the seven numbers is connected with one of the traditional seven planets which comprise the Sun, the Moon, Mercury, Venus, Mars, Jupiter and Saturn. The discovered planets are not part of the system. Although it is possible for an experienced observer to see Uranus, the planet was unknown in ancient times and therefore is not considered in the context of the present methodology to constitute a visible planet.

The numerological entertainment method and system of the present invention is only concerned with the name that the subject, a person, calls themselves by, that is to say the name that the subject is commonly known as. In this respect the subject's date and time of birth has no relevance to that person's numeral.

In a preferred embodiment, the numerological method and system involves the step of determining a number between 1 and 7 for the subject's name utilising a system of correspondence between the letters of the alphabet and the numbers 1 to 7. This is best explained with reference to the table of FIG. 3 where it can be seen that the letters of the alphabet are presented in a grid of seven columns and 3 complete and 1 incomplete row. The numbers 1 to 7 are assigned to the letters of the alphabet in a repeating pattern starting with the number 1 at A through to the number 7 at the letter G. The letter G is the seventh letter of the alphabet and the respective second, third, fourth, fifth and sixth letters are assigned the numbers 2, 3, 4, 5 and 6 and then the pattern is repeated with the number 1 being assigned to the letter H, the eighth letter of the alphabet so that the pattern is repeated to the letter N, the fourteenth letter of the alphabet and again from O through to U with the letters V, W, X, Y and Z in the fourth incomplete row being assigned the numbers 1, 2, 3, 4 respectively.

As with the Pythagorean system of numerology, each letter in the present embodiment of the invention is linked to a number although the table repeats itself after the seventh letter of the alphabet, not the ninth as in the Pythagorean system.

As with the Pythagorean system each letter of each name of the subject's full name has a number associated with it and these are added together to give a sum S. By way of example, and referring to FIG. 4, the name of the Prime Minister of the United Kingdom, Tony Blair, at the priority date of this application, was presented to show that the Sum S of both names is 32. In order to assign a numeral between 1 and 7 to this number the Sum 32 is divided by 7. Elementary mathematics show that 32 divided by 7 equals 4 remainder 4 and in accordance with the methodology of the embodiments of the present invention the number 4, i.e. the remainder, is the numeral for the name Tony Blair. Where there is an exact division of the Sum S by 7 the method identifies the subject's numeral as being 7. To present the methodology in another way, the subject's numeral may be derived by repeatedly subtracting 7 from the Sum S until it is 7 or less such that the final reduction is the subject's numeral.

As previously mentioned a person can call themselves whatever they like and in this respect a change of name may be considered to change that person's fortune since a name change resulting in a change of numeral will, under current numerological thinking, attract the energies of a different planet. Of course there would be instances where a name change will not change one's numeral, for example before marrying Margaret Thatcher was Margaret Roberts and her numeral, under the system described above, was 5 and she remained 5 when she married to become Margaret Thatcher. The methodology of the present invention may therefore be considered to encapsulate the two concepts of fate and free will since a person may change their name or call themselves what they like at any time during their life.

It is to be understood that the methodology disclosed herein can be used for other alphabets in languages having more or less than 26 letters. Since the principle remains the same the alphabet of the subject language is presented on a grid of 7 columns and each letter of that alphabet is assigned a number in the manner of FIG. 3. For example the Russian alphabet with 33 letters would take up 4 full rows and fill up the first 5 spaces of the fifth row.

The astrological and numerological methodology of the present invention places considerable emphasis on the planet associated with the numeral and when the methodology is used for prediction the movements of the Sun, the Moon and the planets will be seen as having an effect on people's lives according to the numeral associated with their name. Thus, in the case of Tony Blair, having the numeral 4 the movement of the planet Venus through the signs of the Zodiac, and its contacts with other heavenly bodies, will have an impact on his life and fortune.

The planets assigned to the numerals 1 to 7 are represented in the table of FIG. 5 where it can be seen that the numeral 1 is assigned to the Sun, 2 to the Moon, 3 to Mercury, 4 to Venus, 5 to Mars, 6 to Jupiter and 7 to Saturn. As previously mentioned this allocation of numerals to planets is not considered essential to the methodology of the present invention as the invention contemplates other embodiments having different orders of assignment of numerals to planets.

As has previously been discussed the subject's element is determined by their date and time of birth and therefore once the subject's numeral has been identified these distinct astrological and numerological classifications can be combined to provide a combined astrological and numerological classification for the subject. For example, the United Kingdom Prime Minister Tony Blair's star sign is Taurus and therefore he has Earth as his element. Four is his numeral so his combination is Earth 4. In this respect it will be understood that every human being, at least in a society that has an alphabet, has a combination and with 4 elements and 7 numerals the number of possible combinations is 28, that is to say the methodology of the present invention provides 28 combined astrological and numerological classifications.

The methodology of the present invention also contemplates a table of 7 columns having the numerals 1 to 7 at the head of the columns then followed by a plurality of rows of successive numbers to assist the user in identifying their numeral from the sum of the numbers found by adding the numbers associated with each letter of each name of their full name. In the case of the name Tony Blair having a sum S of 32 the existence of such a table would readily identify 32 in the column of numeral 4. It is contemplated that 15 columns, to cover the range of numbers 1 to 105, would be sufficient to cover most people's names but of course a longer table could be provided if required or if not the user could revert to elementary divisional mathematics to derive their numeral as previously described.

The present invention also contemplates embodiments which enable a user to determine which numeral 1 to 7 their name will generate, keeping their surname fixed but altering their first name. This aspect of the invention may be useful for choosing baby's names or selecting a different first name when the user desires to have a particular numeral. This is best understood with reference to FIG. 6 and FIGS. 7A and 7B which illustrate a first approach. The first step of this methodology is to identify the numeral for just the surname. In the example shown in FIG. 6 the surname Blair is 2+5+1+2+4=14, which according to the methodology previously disclosed reduces to 7 because 14−7=7.

In this first approach a table of first names are presented, which could be divided into boys and girls first names, although it is possible that they could be grouped together. Referring to FIGS. 7(A) and 7(B) the numbers in the top row are the numerals derived from the subject's surname. First names can then be identified if the numeral for the combined name is pre-selected. For example, if the surname is Blair, which as previously shown has the numeral 7, the final column of the table of FIG. 7(A) applies and it is possible to select a first name having the pre-selected numeral for the full name. In this respect the name Andrew Blair has a numeral of 2 as does Brian Blair. Chris Blair has a numeral of 1, Alison Blair has a numeral of 7 and Anna Blair has a numeral of 2.

As will be appreciated by those of skill in the art, an alternative approach is taught to respectively group the names (as noted above), into 7 groups for example as below.

### Group 1:

If the surname has numeral 1, the following first names give a numeral of 2

If the surname has numeral 2, the following first names give a numeral of 3

If the surname has numeral 3, the following first names give a numeral of 4

If the surname has numeral 4, the following first names give a numeral of 5

If the surname has numeral 5, the following first names give a numeral of 6

If the surname has numeral 6, the following first names give a numeral of 7

If the surname has numeral 7, the following first names give a numeral of 1

For example, Julie, Sandra, Chris, Peter, etc.

### Group 2

If the surname has numeral 1, the following first names give a numeral of 3

If the surname has numeral 2, the following first names give a numeral of 4

If the surname has numeral 3, the following first names give a numeral of 5

If the surname has numeral 4, the following first names give a numeral of 6

If the surname has numeral 5, the following first names give a numeral of 7

If the surname has numeral 6, The following first names give a numeral of 1

If the surname has numeral 7, the following first names give a numeral of 2

For example, Anna, Xena, Andrew, Brian, Frederick, Luigi, etc

### Group 3

If the surname generates numeral 1, the following first names give a numeral of 4

If the surname generates numeral 2, the following first names give a numeral of 5

If the surname generates numeral 3, the following first names give a numeral of 6

If the surname generates numeral 4, the following first names give a numeral of 7

If the surname generates numeral 5, the following first names give a numeral of 1

If the surname generates numeral 6, the following first names give a numeral of 2

If the surname generates numeral 7, the following first names give a numeral of 3

For example, Fiona, etc.

### Group 4

If the surname generates numeral 1, the following first names give a numeral of 5

If the surname generates numeral 2, the following first names give a numeral of 6

If the surname generates numeral 3, the following first names give a numeral of 7

If the surname generates numeral 4, the following first names give a numeral of 1

If the surname generates numeral 5, the following first names give a numeral of 2

If the surname generates numeral 6, the following first names give a numeral of 3

If the surname generates numeral 7, the following first names give a numeral of 4

For example, Charlotte, Julia, etc

### Group 5

If the surname generates numeral 1, the following first names give a numeral of 6

If the surname generates numeral 2, the following first names give a numeral of 7

If the surname generates numeral 3, the following first names give a numeral of 1

If the surname generates numeral 4, the following first names give a numeral of 2

If the surname generates numeral 5, the following first names give a numeral of 3

If the surname generates numeral 6, the following first names give a numeral of 4

If the surname generates numeral 7, the following first names give a numeral of 5

For example, Rachel, Tamara, etc

### Group 6

If the surname generates numeral 1, the following first names give a numeral of 7

If the surname generates numeral 2, the following first names give a numeral of 1

If the surname generates numeral 3, the following first names give a numeral of 2

If the surname generates numeral 4, the following first names give a numeral of 3

If the surname generates numeral 5, the following first names give a numeral of 4

If the surname generates numeral 6, the following first names give a numeral of 5

If the surname generates numeral 7, the following first names give a numeral of 6

For example, Anne, Tasmin, etc

### Group 7

If the surname generates numeral 1, the following first names give a numeral of 1

If the surname generates numeral 2, the following first names give a numeral of 2

If the surname generates numeral 3, the following first names give a numeral of 3

If the surname generates numeral 4, the following first names give a numeral of 4

If the surname generates numeral 5, the following first names give a numeral of 5

If the surname generates numeral 6, the following first names give a numeral of 6

If the surname generates numeral 7, the following first names give a numeral of 7

For example, Alison, etc

In view of the above examples, it will be appreciated and understood that the proposed entertainment methodology of selecting a first name when the surname is fixed may be readily and functionally automated and implemented in a computer system comprising a database of boys and girls names so that the user only has to input the characters of the surname to be presented with a list of possible names corresponding to a pre-selected numeral for the subject's full name. It is possible of course that such a system could be implemented on a server connected to the internet so that subscribers to the service could access the database to select a baby's name or even change their own name. In the case of the latter appropriate links could be provided to other web pages on the same website or other service providers that offer help and assistance to those who wish to change their name, including for example legal representatives capable of completing the legal formalities for changing the subject's name with the legal authorities of the jurisdiction in which the subject resides. Such a system could generate income for the service provider depending upon the income generated by the legal representatives from such Internet referrals.

Embodiments of the present invention are also contemplated in which individuals may obtain information identifying celebrities and other famous people that share their element and numeral combination. For example if using the methodology of the present invention a subject's element and numeral combination was identified as Earth 3. That individual would share the same classification with the following famous/celebrity Earth 3's:

Agatha Christie, Michael Schumacher, Janis Joplin, Ludwig Wittgenstein, Sid James, Tony Hancock, Idi Amin, Kenny Everett, David Bowie, Shane Wame, Stephen Fry, Ben Elton, Des O'Connor, Greta Garbo, Alan Bennett, David Bailey, Yousuf Karsh, Stella McCartney, Gustav Holst, Albert Hofiann, Leo Sternbach, Greg Rusedski, Jonathan Edwards, Orson Welles, George Foreman, Vinnie Jones, Walter Mondale, Jerry Seinfeld, Sandi Toksvig, Joanna Lumley, Norman Lamont, Anne Diamond.

The methodology of the present invention also contemplates embodiments where the numerals 1 to 7 are linked or assigned to the 7 deadly sins and the contrary virtues. This will be more clearly understood from the table shown in FIG. 8 where the numerals 1 to 7 are assigned in that order to the deadly sins of pride, laziness, envy, lust, anger, gluttony, avarice and in that same order to the contrary virtue or protective virtues of humility, diligence, kindness, courage, patience, restraint and generosity.

The methodology of the present invention may also be used to predict a subject's potential for high achievement or fame. One embodiment contemplates 4 ratings, namely very high, high, average and low. For each of the element and numeral combinations an overall rating of potential achievement or fame is assigned plus a specific rating for one or more specific activities. This may be more clearly understood with reference to the table of FIG. 9 where the potential for success in various activities is shown for an Earth 3 classification. As can be seen the overall fame potential is low but in the individual categories acting is average, business success is low, comedy high, media and TV average, music low, politics average, sport very high and writing high. Therefore it may be considered that an Earth 3 would excel in sport but would be unlikely to find fame in business.

In the aforementioned embodiments subjects (people) are classified according to their element and numeral. For example, they may be a Fire One, Earth Two, Air Seven. In another embodiment of the invention the first part of the classification, the element, remains the same. People are still known as Fires, Earths, etc. However, the numeral part is changed, to the name of an archetype, or ‘navigator’. The numeral part is calculated using the method of the present invention as previously described, but it is the converted into the name of a navigator. Navigators corresponding to each of the seven numerals are presented in the table of FIG. 10. The relationship between number and planet is maintained in this embodiment as previously set out in FIG. 5:

In this embodiment of the proposed entertainment system a person is designated as having an element and a navigator. If a subject's name reduces to the numeral one, it follows that that person is a Hero. A designated ‘Fire’ person with one as their numeral is therefore a Fire Hero, Fire is their element, Hero is their navigator. In this embodiment a person would never refer to themselves as a Fire One. Once a person's numeral was determined they would refer to their navigator instead. For example, an Earth Three in the previous embodiment becomes an Earth Messenger, a Water Seven becomes a Water Controller. Although the terminology has changed, the meanings remain the same.

If an individual's navigator in this embodiment is determined electronically, for example by means of a computer program, their number is effectively hidden from them and the rest of the outside world. A user would enter their name into an input device and the processor would compute their navigator.

The present entertainment system and classification invention also contemplates a variation on the methodology previously described with reference to FIGS. 7(A) and 7(B). This methodology can be adjusted, to yield navigators rather than numerals. This method substitutes the numeral for the navigator as previously described so that the table of FIG. 7a is changed to that of FIG. 11. It would still be necessary to determine the numeral of the subject's last name, which is why the top row remains the same.

Having described at least one of the preferred embodiments of the present invention with reference to the accompanying drawings, it is to be understood that the invention is not limited to those precise embodiments, and that various changes, modifications, and adaptations may be effected therein by one skilled in the art without departing from the scope or spirit of the invention as defined in the appended claims.

What is claimed is:

1. An entertainment classification method for determining a combined astrological and numerological classification for a subject, in a question and answering session, said method comprising the steps of:
interactively communicating, via an electronic interactive communications device, a series of questions to a user attempting to establish a combined astrological and numerological classification of a subject based upon a number of parameter queries eliciting answers;
permitting said user to provide an answer to said series of questions; said answers including at least an answer of said subject's name, date of birth, and optionally time of birth;
identifying an astrological classification for said subject from said subject's date of birth and optionally time of birth, said astrological classification comprising at least said subject's zodiac sign and/or associated element; and,
identifying a numerological classification for said subject; said step of identifying a numerological classification including the steps of:
determining a number between 1 and n for said subject's name utilising a system of correspondence between the letters of the alphabet and said numbers 1 to n,
summing the numbers for each letter of each said name of said subject's full name or name by which said subject is known and dividing the sum S by n,
wherein if the sum S is exactly divisible by n the subject's numerological classification is n and if the sum S is not exactly divisible by n the subject's numerological classification is the remainder R, where R is between 1 and n−1;
combining said subject's astrological and numerological classifications to generate a combined astrological and numerological classification for said subject; and
interactively communicating, via said interactive communications device, said combined astrological and numerological classification to said user

2. A computer memory interactive system, storing thereon an application program for controlling the execution of a processor to determine a combined astrological and numerological classification for a subject, in a question and answering session, the computer memory interactive system controlling the processor to:
display a set of one or more questions to a user attempting to determine a combined astrological and numerological classification for a subject;
permit said user to provide an answer to said set of one or more questions, said answers including at least said subject's name and date of birth;
identify an astrological classification for said subject from said subject's date of birth, said astrological classification comprising at least said subject's zodiac sign and/or associated element; and,
determine a number between 1 and n for said subject's name utilising a system of correspondence between the letters of the alphabet and said numbers 1 to n,
sum the numbers for each letter of each name of said subject's full name or name by which said subject is known and divide the sum S by n, and if the sum S is exactly divisible by n the subject's numerological classification is n and if the sum S is not exactly divisible by n the subject's numerological classification is the remainder R, where R is between 1 and n−1; and,
combine said subject's astrological and numerological classifications to generate a combined astrological and numerological classification for said subject;
communicate said combined astrological and numerological classification to said user.

3. An entertainment system, for determining a combined astrological and numerological classification for a subject, in a question and answering session, said system comprising:
an application program to control a processor for displaying, on a display means, a series of questions to a user attempting to establish a combined astrological and numerological classification of a subject;
data input means adapted to interface with said processor to permit said user to provide an answer to said set of one or more questions including at least said subject's name and date of birth;
a database into which said answers are stored by said processor under instructions by said application program;
said processor allowing said user to answer said set of one or more selected questions using said data input means;
said application program instructs said processor to: (a) identify an astrological classification for a subject from said subject's date of birth, said astrological classification comprising at least said subject's zodiac sign and/or associated element; (b) determine a number between 1 and n for said subject's name utilising a system of correspondence between the letters of the alphabet and said numbers 1 to n, (c) sum the numbers for each letter of each name of said subject's full name or name by which said subject is known and dividing the sum S by n, and, if the sum S is exactly divisible by n the subject's numerological classification is n and if the sum S is not exactly divisible by n the subject's numerological classification is the remainder R, where R is between 1 and n−1; and, wherein said application program instructs said processor to combine said subject's astrological and numerological classifications to provide a combined astrological and numerological classification for said subject and thereafter form a database structure in said database from said provided information for the creation of an astrological and numerological classification for said subject.

4. A system for deriving a combined astrological and numerological classification for an entertained subject, said system comprising:
means for identifying an astrological classification for a subject from said subject's date and time of birth, said astrological classification comprising at least said subject's zodiac sign and/or associated element; and,
means for identifying a numerological classification for a subject, including:
means for determining a number between 1 and n for said subject's name utilising a system of correspondence between the letters of the alphabet and said numbers 1 to n,
means for summing the numbers for each letter of each name of said subject's full name or name by which said subject is known and dividing the sum S by n, and,
wherein if the sum S is exactly divisible by n the subject's numerological classification is n and if the sum S is not exactly divisible by n the subject's numerological classification is the remainder R, where R is between 1 and n−1; and,
means for combining said subject's astrological and numerological classifications to provide a combined astrological and numerological classification for said subject.

5. An astrological and numerological method for deriving a combined astrological and numerological classification for a subject, said method comprising the steps of:
identifying an astrological classification for a subject from said subject's date and optionally time of birth, said astrological classification comprising at least said subject's zodiac sign and/or associated element; and,
identifying a numerological classification for a subject; said step of identifying a numerological classification comprising the steps of:
determining a number between 1 and n for said subject's name utilising a system of correspondence between the letters of the alphabet and said numbers 1 to n,
summing the numbers for each letter of each name of said subject's full name or name by which said subject is known and dividing the sum S by n,
wherein if the sum S is exactly divisible by n the subject's numerological classification is n and if the sum S is not exactly divisible by n the subject's numerological classification is the remainder R, where R is between 1 and n−1; and,
combining said subject's astrological and numerological classifications to provide a combined astrological and numerological classification for said subject.

6. A method as claimed in claim 5, further comprising the step of assigning a planet to each respective numerological classification 1 to n.

7. A method as claimed in claim 5, wherein said planets are assigned to said numerological classifications 1 to n in any order.

8. A method as claimed in claim 7, wherein said planets are assigned to said numerological classifications 1 to n in one of a Pythagorean order and a Chaldean order with the first planet of said orders assigned to any one of the classifications 1 to n.

9. A method as claimed in claim 7 wherein the planets are assigned to said numerological classifications 1 to n in the order: Sun, Moon, Mercury, Venus, Mars, Jupiter, Saturn.

10. A method as claimed in claim 9, wherein the order in which the planets are assigned is such that the numerological classification 1 is assigned to the Sun and the numerological classification 7 is assigned to Saturn.

11. A method as claimed in claim 7, wherein n=7.

12. A method as claimed in claims 7, further comprising the step of making predictions, forecasts, or any other astrological entertainment techniques according to astrological methods associated with the position and movement of the planet assigned to the subject's numerological classification.

13. A method as claimed in claim 7, wherein said combined astrological and numerological classification begins with said subject's element and ends with said subject's numerological classification.

14. A method as claimed in claim 7, wherein said elements comprise the four traditional astrological elements of Fire, Earth, Air and Water.

15. A method as claimed in claim 7, claim further comprising the step of assigning a respective deadly sin and/or contrary virtue to each of said numerological classifications 1 to n.

16. A method as claimed in claim 7, further comprising the step of assigning externally determined values of a subject's potential for success to respective skills for each astrological numerological combination

17. A method as claimed in claim 7, further comprising the step of storing the names and combined astrological numerological classifications of a plurality of famous people and retrieving the names of said people for association with a subject having a matching classification.
